(19) United States
(12) Patent Application Publication
(10) Pub. No.: US 2014/0163154 A1
(43) Pub. Date: Jun. 12, 2014

(54) Polypropylene compounds with enhanced haptics and methods of making same

(71) Applicant: Asahi Kasei Plastics North America Inc., (US)

(72) Inventors: Katherine M. Shipley, Mason, MI (US); Sameer G. Mehta, Novi, MI (US); Vaibhav Vishnu Apte, Farmington Hills, MI (US)

(73) Assignee: ASAHI KASEI PLASTICS NORTH AMERICA INC., Fowlerville, MI (US)

(21) Appl. No.: 13/836,167

(22) Filed: Mar. 15, 2013

Related U.S. Application Data
(60) Provisional application No. 61/736,009, filed on Dec. 12, 2012.

(51) Int. Cl. C08L 23/06

(52) U.S. Cl. CPC C08L 23/06
USPC 524/494; 524/528; 524/505; 524/514

(57) ABSTRACT

Polypropylene compositions with enhanced haptics and a process for making the same are disclosed comprising a blend of reactor TPO, and filler. The compositions may further comprise homopolymer polypropylene, random copolymer polypropylene, polyamide 6, ethylene-C₄₋₈ α-olefin plastomer, plastomer propylene-ethylene copolymer, SEBS triblock thermoplastic elastomer, maleic anhydride grafted PP, anti-scratch additives, antioxidants, UV stabilizers, and colorants. A process is also disclosed for preparing the polypropylene compositions with enhanced haptics.

### RELATED APPLICATION

This application claims priority to U.S. Provisional Application No. 61/736,009 filed Dec. 12, 2012, the entire disclosure of which is incorporated herein by reference.

### FIELD OF THE INVENTION

The present invention relates generally to polypropylene (“PP”) compounds with enhanced haptics having a wide variety of uses, including uses in the interiors of automobiles.

### BACKGROUND OF THE INVENTION

Because polypropylene (PP) is low in cost but has outstanding mechanical properties and moldability, it accounts for more than half of all the plastic materials used in automobiles. PP compounds are used for a variety of parts, including bumper fascias, instrumental panels and door trims. Several grades of PP compounds, with their diverse performance characteristics, have been developed by compounding PP with various other materials according to the performance requirements of the intended parts. PP, particularly glass fiber reinforced PP, demonstrates advantages in improved strength, stiffness and higher temperature capability over other polyolefins. These advantages in strength and stiffness, however, come at a cost of reduced softness to the touch. Studies show that haptics—the science of the sense of touch—plays a role in influencing decision making processes. Soft surfaces, for example, augment the user experience and provide value added characteristics to critical applications. Traditionally, those in the industry employ techniques such as cross linking or overmolding to create materials with the desired haptic properties.

For example, cross-linked foam blends of PP and polyethylene (“PE”) sheet stock are widely used as padding in car interiors in door trim panels, instrument panels, glove box doors, roof liners, pillars and setbacks. Polypropylene contributes durability, high thermal stability, and mechanical stiffness, while polyethylene provides elongation, ductility, and softness.

The overmolding process involves the use of two separate materials to form one cohesive component. There are two types of overmolding: insert and “two-shot”. Insert overmolding, the more popular process, is an injection molding process where one material (usually elastomeric) is molded “over” a secondary “substrate” material (usually a rigid plastic or object).

These methods, however, present disadvantages such as higher tooling costs and more complex manufacturing procedures. In addition, the recyclability of materials made by these procedures is limited.

### SUMMARY OF THE INVENTION

Described herein are polypropylene compositions with enhanced haptics and processes for preparing the compositions, and articles of manufacture prepared from the compositions. In one embodiment, a Polypropylene composition is disclosed comprising a blend of about 10-90% by weight of Reactor Thermoplastic Polyolefin (“TPO”) and 5-65% by weight of reinforcing filler. Reinforcing filler may include talc, calcium carbonate, mica, pyrophyllite, glass fiber or wollastonite. One of the more preferred reinforcing filler for these PP compounds disclosed is glass fiber. The glass fiber used can either be of short glass fiber or long glass fiber type or blends of both these type of glass fibers in the finished polypropylene composition that is used for subsequent injection molding, compression molding, rotational molding, extrusion, blow molding or thermoforming. In other embodiments, the compositions further comprise out homopolymer polypropylene, random copolymer polypropylene, Polyamide 6 (“PA6”), ethylene-C₄₋₈ α-olefin plastomer, plastomer propylene-ethylene copolymer, polystyrene-block-poly(ethylene-co-butylene)-block-polystyrene (“SEBS”) triblock thermoplastic elastomer, anti-scratch additives, antioxidants, maleic anhydride grafted polypropylene, UV stabilizers, and/or colorants.

Further, a process for the preparation of a polypropylene composition with enhanced haptics is provided comprising batch or continuous mixing about 10-90% by weight of Reactor TPO, and 5-65% by weight of reinforcing filler. The resultant compositions may be processed into various forms, including, but not limited to, strands that are pelletized for subsequent injection molding, compression molding, rotational molding, extrusion, blow molding or thermoforming to produce finished articles and test specimens. In other embodiments, the process comprises batch or continuous mixing the forgoing composition with homopolymer polypropylene, random copolymer polypropylene, PA6, ethylene-C₄₋₈ α-olefin plastomer, plastomer propylene-ethylene copolymer, polystyrene-block-poly(ethylene-co-butylene)-block-polystyrene (SEBS) triblock thermoplastic elastomer, anti-scratch additives, antioxidants, maleic anhydride grafted polypropylene, UV stabilizer, and/or colorants.

The resulting polypropylene compositions with enhanced haptics exhibit improved haptic properties such as softness to touch while maintaining ductile failure mode, flexural modulus and rigidity. These and other features and advantages will be apparent from the following brief description of the drawings, detailed description, and appended claims and drawings.

### BRIEF DESCRIPTION OF THE DRAWINGS

Embodiments of the invention will now be described, by way of example, with reference to the accompanying drawings, wherein:

FIG. 1 illustrates a schematic description of a process for batch continuous mixing of the compounds of the invention.

FIG. 2 illustrates an extruder of the type used in the invention with zones identified.

FIG. 3 Illustrates the glass fiber length distribution in an embodiment of the invention.

FIG. 4 Illustrates the glass fiber length distribution in another embodiment of the invention.

FIG. 5 Illustrates the glass fiber length distribution in another embodiment of the invention.

FIG. 6 Illustrates the glass fiber length distribution in another embodiment of the invention.

FIG. 7 Illustrates the glass fiber length distribution in another embodiment of the invention.

### DETAILED DESCRIPTION

Described herein are polypropylene compositions with enhanced haptics and processes for preparing the same. The present invention also relates to articles of manufacture prepared from the compositions. Reference will now be made in detail to embodiments of the present disclosure, examples of which are described herein and illustrated in the accompanying drawings. While the invention may be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

Unless otherwise indicated, all numbers expressing quantities of ingredients, properties such as molecular weight, reaction conditions, and so forth used in the specification and claims are to be understood as being modified in all instances by the term “about”. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

In one embodiment, a polypropylene composition with enhanced haptics is disclosed comprising a blend of about 10-90% by weight of Reactor TPO, and 5-65% by weight of reinforcing filler.

In an alternative embodiment, the polypropylene compositions with enhanced haptics further comprise up to about 0-40% by weight of homopolymer polypropylene. In another embodiment of the polypropylene compositions with enhanced haptics comprise about 0-50% by weight of random copolymer polypropylene. In another embodiment of the polypropylene compositions with enhanced haptics comprise about 0-10% by weight of PA6. In another embodiment of the polypropylene compositions with enhanced haptics comprise about 0-40% by weight of ethylene-C₄₋₈ α-olefin plastomer. In another embodiment of the polypropylene compositions with enhanced haptics comprise about 0-40% by weight of plastomer propylene-ethylene copolymer. In another embodiment of the polypropylene compositions with enhanced haptics comprise about 0-40% by weight of polystyrene-block-poly(ethylene-co-butylene)-block-polystyrene (SEBS) triblock thermoplastic elastomer. In another embodiment of the polypropylene compositions with enhanced haptics comprise about 0-3% by weight of anti-scratch additives. In another embodiment of the polypropylene compositions with enhanced haptics, the compositions comprise up to 0-3% by weight of antioxidants. In another embodiment of the polypropylene compositions with enhanced haptics, the compositions comprise up to 0-3% by weight of maleic anhydride grafted polypropylene. In another embodiment of the polypropylene compositions with enhanced haptics, the compositions comprise up to 0-2% by weight UV stabilizers. In another embodiment of the polypropylene compositions with enhanced haptics, the compositions comprise up to up to 0-4% by weight of colorants. The weight percent values disclosed are based on the weight of the total composition unless otherwise noted.

In another embodiment, a process for the preparation of a polypropylene composition with enhanced haptics is provided comprising batch or continuous mixing about 10-90% by weight of Reactor TPO, and 5-65% by weight of reinforcing filler. The resultant compositions may be processed into various forms, including, but not limited to, strands that are pelletized for subsequent injection molding, compression molding, rotational molding, extrusion, blow molding or thermoforming to produce finished articles and test specimens. In another embodiment, the process comprises batch or continuous mixing the forgoing composition with about 0-40% by weight of homopolymer polypropylene. In an additional embodiment, the process comprises batch or continuous mixing the foregoing composition with about 0-50% by weight of random copolymer polypropylene. In an additional embodiment the polypropylene compositions with enhanced haptics comprise about 0-10% by weight of PA6. In an additional embodiment, the process comprises batch or continuous mixing the foregoing compositions with up to about 0-40% by weight of ethylene-C₄₋₈ α-olefin plastomer. In an additional embodiment, the process comprises batch or continuous mixing the foregoing compositions with up to about 0-40% by weight of plastomer propylene-ethylene copolymer. In an additional embodiment, the process comprises batch or continuous mixing the foregoing compositions with up to about 0-40% by weight of polystyrene-block-poly(ethylene-co-butylene)-block-polystyrene (SEBS) triblock thermoplastic elastomer. In an additional embodiment, the process comprises batch or continuous mixing the foregoing compositions with up to about 0-3% by weight of anti-scratch additives. In an additional embodiment, the process comprises batch or continuous mixing the foregoing compositions with up to about 0-3% by weight of antioxidants. In an additional embodiment, the process comprises batch or continuous mixing the foregoing compositions with up to about 0-3% by weight of maleic anhydride grafted polypropylene. In a further embodiment the process comprises batch or continuous mixing the foregoing compositions with about 0-2% by weight of a UV stabilizer. Alternatively, the process comprises batch or continuous mixing the foregoing compositions with about 0-4% by weight of colorants. The weight percent values disclosed are based on the weight of the total composition unless otherwise noted.

Table 1 provides a list of components suitable for use in the thermoplastic compositions and examples discussed herein. It will be understood that the components listed in Table 1 are given for the purpose of illustration and do not limit the invention.

TABLE 1

| Material Supplier and Grade | |
|---|---|
| Name | Material Description |
| Equistar Chemicals Hifax CA138 | Reactor TPO |
| Equistar Chemicals Hifax CA10A | Reactor TPO |
| Equistar Chemicals Adflex Q200F | Reactor TPO |
| Braskem PP TR3350C | Random Copolymer PP |
| Dow Versify 4301 | Plastomer, Propylene-Ethylene |
| | Copolymer |
| Formosa Formolene 4100T | Homopolymer PP |
| Chemtura Polybond 3200 | Maleic Anhydride Grafted |
| | Polypropylene |
| Standridge Color SSC22598 | Carbon Black Masterbatch, |
| | 49% Carbon Black in LLDPE |
| | carrier |
| Ciba Irganox 1010 | Sterically hindered phenolic |
| | antioxidant |
| Ciba Irgafos 168 | Trisaryl phosphite processing |
| | stabilizer |
| Equistar Chemicals Profax 6301 | Homopolymer PP flake |
| Johns Manville EC13 738 3/16″ | 13 Micron diameter short glass |
| Thermoflow Series | fiber for PP |
| Kraton G1652M | polystyrene-block- |
| | poly(ethylene-co-butylene)- |
| | block-polystyrene (SEBS) |
| | triblock thermoplastic |
| | elastomer |
| Kraton G4609H | White mineral oil extended |
| | polystyrene-block- |
| | poly(ethylene-co-butylene)- |
| | block-polystyrene (SEBS) |
| | triblock thermoplastic |
| | elastomer |
| Dow Developmental Elastomer | Plastomer, Propylene-Ethylene |
| DE4301.05 | Copolymer |
| Dow Engage 8100 | Polyolefin elastomer, Ethylene- |
| | Octene Copolymer |
| Dow Infuse 9817 | Olefin block copolymer |
| Dow Infuse 9807 | Olefin block copolymer |
| Evonik Tegomer H-Si 6440P | Wax type siloxane-co-polyester |
| | anti-scratch additive |
| Honeywell H8202NL | Polyamide 6 |
| COMUSA LLC Funcster LR26YA8 | 58% Long Glass Fiber |
| | Reinforced, Homopolymer |
| | Polypropylene |
| Cytec Cyasorb UV-3346 | Hindered Amine Light |
| | Stabilizer (“HALS”) |
| Cytec Cyasorb UV-3853S | Hindered Amine Light |
| | Stabilizer (“HALS”) |

The inventive compounds disclosed can be produced in a batch or continuous mixing operation. Extruders having a variety of screw configurations such as a single screw or a twin screw configuration can be used to produce these compounds. Twin screw extruders can have either a co-rotating or counter-rotating screw. It is preferred to use a co-rotating twin screw extruder such as is commercially available from Coperion with headquarters in Stuggart, Germany. The inventive compounds disclosed were produced using a 28 mm screw diameter Coperion co-rotating twin screw extruder.

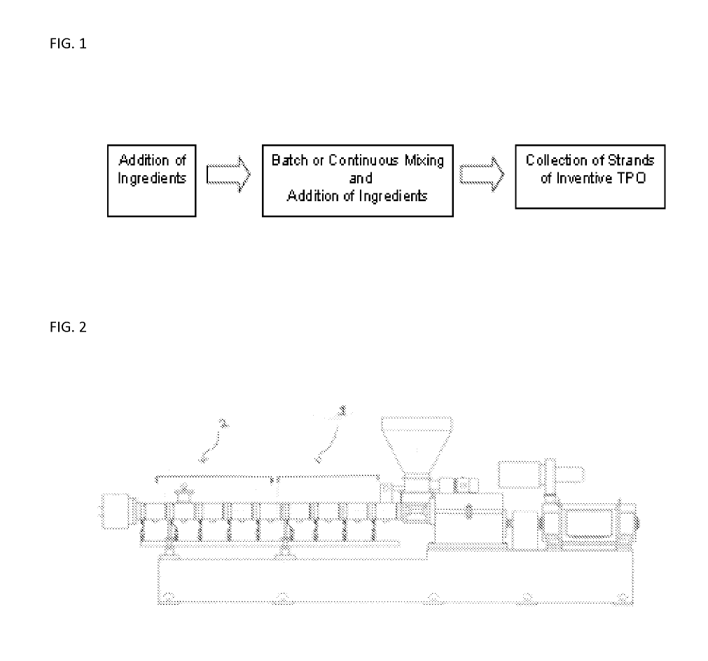

FIG. 1 is a schematic depiction of a process used to create the inventive compounds. In the first step of the process initial ingredients are added. In the second step the initial ingredients are mixed and additional ingredients are added. In the third step, strands of the inventive compound are collected.

Extruders have various barrel heating zones and other processing parameters that interact with the screw elements to produce a compounded material. The acceptable, desirable, and preferred ranges for the key variables are listed below:

Processing Conditions

| Condition | Acceptable | Desirable | Preferred |
|---|---|---|---|
| Zone 1-4 Temperature (° F.) | 380-510 | 420-500 | 460 |
| Zone 5-8 Temperature (° F.) | 380-510 | 420-500 | 460 |
| Die Temperature (° F.) | 380-510 | 420-500 | 460 |
| Screw Rotation (rpm) | 300-1000 | 300-700 | 400 |
| Torque (%) | 30-95 | 50-85 | 60 |

FIG. 2 is a depiction of an extruder of the type that may be used in creating the inventive compounds. The primary heating area 1 is comprised of a multitude of heating zones for extrusion. The secondary heating area 2 is comprised of an additional multitude of heating zones for extrusion.

Location of ingredients added into the extruder can be varied depending on the desired dwell time and mixing needed. The table below shows acceptable locations where the ingredients can be added:

Ingredient Feeding Locations

| Ingredient | Feeding Location |
|---|---|
| Polyolefins | Throat or Downstream or Both |
| Glass Fibers | Downstream |
| Mineral Fillers | Throat or Downstream or Both |
| Elastomers | Throat |
| Performance Additives | Throat |
| Heat Stabilizers | Throat |
| UV Stabilizers | Throat |
| Pigments/Carbon Black Masterbatch | Throat |

Typically the output of the extruder is strands that are pelletized for subsequent extrusion or injection molding to produce finished articles and test specimens.

### EXAMPLES

The following examples illustrate the present invention. It is understood that these examples are given for the purpose of illustration and do not limit the invention. In the examples, all parts and percentages are by weight based on the total weight of the composition unless otherwise specified. In case of Multiaxial Impact test also sometimes referred to as Instrumented Dart Impact, the failure mode of plaques is noted in parentheses. (D) denotes ductile failure mode and (B) denotes brittle failure mode. In case a set of samples exhibited a mixture of ductile and brittle failure mode then the respective number of samples for each failure mode is noted in parentheses.

The APNA test method to rank softness is as follows:

1) Right hand needs to be dry and free of any oil residue prior to testing.

2) Rub index finger on molded plaque for a length of −5 centimeters.

3) Repeat three times and assign rating of excellent, acceptable or unacceptable.

Composition 1 was prepared by melt mixing using a twin-screw extruder according to the scheme in FIG. 1. The composition of 1, in weight percent of total composition, consists of the following:

| Material Supplier and | | |
|---|---|---|
| Grade Name | Material Description | X120111-A |
| Equistar Chemicals Hifax | Reactor TPO | 61.95 |
| CA10A | | |
| Dow Versify 4301 | Plastomer, Propylene- | 10.00 |
| | Ethylene Copolymer | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Cytec Cyasorb UV-3346 | HALS | 0.30 |
| Cytec Cyasorb UV-3853S | HALS | 0.45 |
| Johns Manville EC13 738 | 13 Micron diameter short | 25.00 |
| 3/16″ Thermoflow Series | glass fiber for PP | |

Composition 1 exhibited the following properties:

| ITEM # | TEST DESCRIPTION | UNITS | TEST METHOD | X120111-A |
|---|---|---|---|---|
| 1 | Melt Flow Rate, 230° C./2.16 kg | g/10 min | ISO 1133 | 0.7 |
| 2 | Filler Content, 1500° F./10 minutes | % | ISO 3451 | 25.2 |
| 3 | Tensile Strength, 5 mm/min | Mpa | ISO 527 | 20.0 |
| 4 | Tensile Elongation at Break, 5 mm/min | % | ISO 527 | 49.2 |
| 5 | Flexural Modulus Chord, 2 mm/min | Mpa | ISO 178 | 717 |
| 6 | Flexural Strength, 2 mm/min | Mpa | ISO 178 | 17.1 |
| 7 | Notched Charpy Impact, 23° C. | KJ/m² | ISO 180 | 61.3 |
| 8 | Notched Charpy Impact, −30° C. | KJ/m² | ISO 180 | 29.1 |
| 9 | Hardness, Shore D | | ISO 2039 | 45 |
| 10 | Softness Rating, Grain CPM541 | excellent, | APNA Method | acceptable |
| 11 | Softness Rating, Grain CPM518 | acceptable or | APNA Method | acceptable |
| | | unacceptable | | |

Composition 2 was prepared by melt mixing using a twin-screw extruder according to the scheme in FIG. 1. The composition of 2, in weight percent of total composition, consists of the following:

| Material Supplier and | | |
|---|---|---|
| Grade Name | Material Description | X120111-B |
| Dow Versify 4301 | Plastomer, Propylene- | 34.00 |
| | Ethylene Copolymer | |
| Braskem PP TR3350C | Random Copolymer PP | 37.95 |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Cytec Cyasorb UV-3346 | HALS | 0.30 |
| Cytec Cyasorb UV-3853S | HALS | 0.45 |
| Johns Manville EC13 738 | 13 Micron diameter short | 25.00 |
| 3/16″ Thermoflow Series | glass fiber for PP | |

Composition 2 exhibited the following properties:

| ITEM # | TEST DESCRIPTION | UNITS | TEST METHOD | X120111-B |
|---|---|---|---|---|
| 1 | Melt Flow Rate, 230° C./2.16 kg | g/10 min | ISO 1133 | 11.5 |
| 2 | Filler Content, 1500° F./10 minutes | % | ISO 3451 | 24.6 |
| 3 | Tensile Strength, 5 mm/min | Mpa | ISO 527 | 37.5 |
| 4 | Tensile Elongation at Break, 5 mm/min | % | ISO 527 | 18.6 |
| 5 | Flexural Modulus Chord, 2 mm/min | Mpa | ISO 178 | 2264 |
| 6 | Flexural Strength, 2 mm/min | Mpa | ISO 178 | 49.0 |
| 7 | Notched Charpy Impact, 23° C. | KJ/m² | ISO 180 | 27.2 |
| 8 | Notched Charpy Impact, −30° C. | KJ/m² | ISO 180 | 6.8 |
| 9 | Hardness, Shore D | | ISO 2039 | 60 |
| 10 | Softness Rating, Grain CPM541 | excellent, | APNA Method | unacceptable |
| 11 | Softness Rating, Grain CPM518 | acceptable or | APNA Method | unacceptable |
| | | unacceptable | | |

Composition 3 was prepared by melt mixing using a twin-screw extruder according to the scheme in FIG. 1. The composition of 3, in weight percent of total composition, consists of the following:

| Material Supplier and | | |
|---|---|---|
| Grade Name | Material Description | X120111-C |
| Equistar Chemicals Hifax | Reactor TPO | 34.00 |
| CA138 | | |
| Equistar Chemicals Hifax | Reactor TPO | 37.95 |
| CA10A | | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Cytec Cyasorb UV-3346 | HALS | 0.30 |
| Cytec Cyasorb UV-3853S | HALS | 0.45 |
| Johns Manville EC13 738 | 13 Micron diameter short | 25.00 |
| 3/16″ Thermoflow Series | glass fiber for PP | |

Composition 3 exhibited the following properties:

| ITEM # | TEST DESCRIPTION | UNITS | TEST METHOD | X120111-C |
|---|---|---|---|---|
| 1 | Melt Flow Rate, 230° C./2.16 kg | g/10 min | ISO 1133 | 0.9 |
| 2 | Filler Content, 1500° F./10 minutes | % | ISO 3451 | 25.0 |
| 3 | Tensile Strength, 5 mm/min | Mpa | ISO 527 | 17.9 |
| 4 | Tensile Elongation at Break, 5 mm/min | % | ISO 527 | 31.6 |
| 5 | Flexural Modulus Chord, 2 mm/min | Mpa | ISO 178 | 1290 |
| 6 | Flexural Strength, 2 mm/min | Mpa | ISO 178 | 21.7 |
| 7 | Notched Charpy Impact, 23° C. | KJ/m² | ISO 180 | 56.4 |
| 8 | Notched Charpy Impact, −30° C. | KJ/m² | ISO 180 | 36.6 |
| 9 | Hardness, Shore D | | ISO 2039 | 52 |
| 10 | Softness Rating, Grain CPM541 | excellent, | APNA Method | unacceptable |
| 11 | Softness Rating, Grain CPM518 | acceptable or | APNA Method | unacceptable |
| | | unacceptable | | |

Composition 4 was prepared by melt mixing using a twin-screw extruder according to the scheme in FIG. 1. The composition of 4, in weight percent of total composition, consists of the following:

| Material Supplier and | | |
|---|---|---|
| Grade Name | Material Description | X120301-A |
| Equistar Chemicals Adflex | Reactor TPO | 53.29 |
| Q200F | | |
| Dow Engage 8100 | Plastomer, Ethylene-Octene | 19.21 |
| | Copolymer | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 4 exhibited the following properties:

| ITEM # | TEST DESCRIPTION | UNITS | TEST METHOD | X120301-A |
|---|---|---|---|---|
| 1 | Melt Flow Rate, 230° C./2.16 kg | g/10 min | ISO 1133 | 0.5 |
| 2 | Filler Content, 1500° F./10 minutes | % | ISO 3451 | 23.6 |
| 3 | Tensile Strength, 5 mm/min | Mpa | ISO 527 | 18.4 |
| 4 | Tensile Elongation at Break, 5 mm/min | % | ISO 527 | 34.4 |
| 5 | Flexural Modulus Chord, 2 mm/min | Mpa | ISO 178 | 622 |
| 6 | Flexural Strength, 2 mm/min | Mpa | ISO 178 | 16.5 |
| 7 | Notched Charpy Impact, 23° C. | KJ/m² | ISO 180 | 50.1 |
| 8 | Notched Charpy Impact, −30° C. | KJ/m² | ISO 180 | 48.3 |
| 9 | Hardness, Shore D | | ISO 2039 | 50 |
| 10 | Softness Rating, Grain CPM541 | excellent, | APNA Method | excellent |
| 11 | Softness Rating, Grain CPM518 | acceptable or | APNA Method | excellent |
| | | unacceptable | | |
| 12 | Multiaxial Impact, 6.7 m/s, 23° C. Energy to max load | J | ASTM D3763 | 16.1 (D) |
| 13 | Multiaxial Impact, 6.7 m/s, 0° C. Energy to max load | J | ASTM D3763 | 13.7 (D) |
| 14 | Multiaxial Impact, 6.7 m/s, −30° C. Energy to max load | J | ASTM D3763 | 10.0 (D)* |

*indicates test specimen cracked, however cracks did not extend outside ring and test specimen did not shatter

Composition 5 was prepared by melt mixing using a twin-screw extruder according to the scheme in FIG. 1. The composition of 5, in weight percent of total composition, consists of the following:

| Material Supplier and Grade | | X120301- |
|---|---|---|
| Name | Material Description | B |
| Equistar Chemicals Hifax | Reactor TPO | 12.98 |
| CA138 | | |
| Equistar Chemicals Adflex | Reactor TPO | 53.29 |
| Q200F | | |
| Formosa Formolene 4100T | Homopolymer PP | 6.23 |
| Chemtura Polybond 3200 | Maleic Anhydride Grafted | 1.00 |
| | Polypropylene | |
| Standridge Color SSC22598 | Carbon Black Masterbatch, | 1.00 |
| | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 5 exhibited the following properties:

| ITEM # | TEST DESCRIPTION | UNITS | TEST METHOD | X120301-B |
|---|---|---|---|---|
| 1 | Melt Flow Rate, 230° C./2.16 kg | g/10 min | ISO 1133 | 0.7 |
| 2 | Filler Content, 1500° F./10 minutes | % | ISO 3451 | 24.4 |
| 3 | Tensile Strength, 5 mm/min | Mpa | ISO 527 | 27.4 |
| 4 | Tensile Elongation at Break, 5 mm/min | % | ISO 527 | 28.9 |
| 5 | Flexural Modulus Chord, 2 mm/min | Mpa | ISO 178 | 1781 |
| 6 | Flexural Strength, 2 mm/min | Mpa | ISO 178 | 29.9 |
| 7 | Notched Charpy Impact, 23° C. | KJ/m² | ISO 180 | 52.0 |
| 8 | Notched Charpy Impact, −30° C. | KJ/m² | ISO 180 | 24.9 |
| 9 | Hardness, Shore D | | ISO 2039 | 60 |
| 10 | Softness Rating, Grain CPM541 | excellent, | APNA Method | acceptable |
| 11 | Softness Rating, Grain CPM518 | acceptable or | APNA Method | acceptable |
| | | unacceptable | | |
| 12 | Multiaxial Impact, 6.7 m/s, 23° C. Energy to max load | J | ASTM D3763 | 14.7 (D) |
| 13 | Multiaxial Impact, 6.7 m/s, 0° C. Energy to max load | J | ASTM D3763 | 12.4 (D) |
| 14 | Multiaxial Impact, 6.7 m/s, −30° C. Energy to max load | J | ASTM D3763 | 5.3 (D)* |

*indicates test specimen cracked, however cracks did not extend outside ring and test specimen did not shatter

Composition 6 was prepared by melt mixing using a twin-screw extruder according to the scheme in FIG. 1. The composition of 6, in weight percent of total composition, consists of the following:

| Material Supplier and Grade | | X120301- |
|---|---|---|
| Name | Material Description | C |
| Equistar Chemicals Hifax | Reactor TPO | 34.29 |
| CA138 | | |
| Equistar Chemicals Adflex | Reactor TPO | 31.97 |
| Q200F | | |
| Formosa Formolene 4100T | Homopolymer PP | 6.24 |
| Chemtura Polybond 3200 | Maleic Anhydride Grafted | 1.00 |
| | Polypropylene | |
| Standridge Color SSC22598 | Carbon Black Masterbatch, | 1.00 |
| | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 6 exhibited the following properties:

| ITEM # | TEST DESCRIPTION | UNITS | TEST METHOD | X120301-C |
|---|---|---|---|---|
| 1 | Melt Flow Rate, 230° C./2.16 kg | g/10 min | ISO 1133 | 0.9 |
| 2 | Filler Content, 1500° F./10 minutes | % | ISO 3451 | 24.5 |
| 3 | Tensile Strength, 5 mm/min | Mpa | ISO 527 | 28.5 |
| 4 | Tensile Elongation at Break, 5 mm/min | % | ISO 527 | 22.5 |
| 5 | Flexural Modulus Chord, 2 mm/min | Mpa | ISO 178 | 1647 |
| 6 | Flexural Strength, 2 mm/min | Mpa | ISO 178 | 33.8 |
| 7 | Notched Charpy Impact, 23° C. | KJ/m² | ISO 180 | 50.1 |
| 8 | Notched Charpy Impact, −30° C. | KJ/m² | ISO 180 | 31.3 |
| 9 | Hardness, Shore D | | ISO 2039 | 55 |
| 10 | Softness Rating, Grain CPM541 | excellent, | APNA Method | acceptable |
| 11 | Softness Rating, Grain CPM518 | acceptable or | APNA Method | acceptable |
| | | unacceptable | | |
| 12 | Multiaxial Impact, 6.7 m/s, 23° C. Energy to max load | J | ASTM D3763 | 12.8 (D) |
| 13 | Multiaxial Impact, 6.7 m/s, 0° C. Energy to max load | J | ASTM D3763 | 10.8 (D) |
| 14 | Multiaxial Impact, 6.7 m/s, −30° C. Energy to max load | J | ASTM D3763 | 7.4 (D)* |

*indicates test specimen cracked, however cracks did not extend outside ring and test specimen did not shatter

Composition 7 was prepared by melt mixing using a twin-screw extruder according to the scheme in FIG. 1. The composition of 7, in weight percent of total composition, consists of the following:

| Material Supplier and Grade | | X120301- |
|---|---|---|
| Name | Material Description | D |
| Equistar Chemicals Hifax | Reactor TPO | 12.98 |
| CA138 | | |
| Equistar Chemicals Adflex | Reactor TPO | 31.97 |
| Q200F | | |
| Formosa Formolene 4100T | Homopolymer PP | 27.55 |
| Chemtura Polybond 3200 | Maleic Anhydride Grafted | 1.00 |
| | Polypropylene | |
| Standridge Color SSC22598 | Carbon Black Masterbatch, | 1.00 |
| | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 7 exhibited the following properties:

| ITEM # | TEST DESCRIPTION | UNITS | TEST METHOD | X120301-D |
|---|---|---|---|---|
| 1 | Melt Flow Rate, 230° C./2.16 kg | g/10 min | ISO 1133 | 2.1 |
| 2 | Filler Content, 1500° F./10 minutes | % | ISO 3451 | 24.9 |
| 3 | Tensile Strength, 5 mm/min | Mpa | ISO 527 | 37.5 |
| 4 | Tensile Elongation at Break, 5 mm/min | % | ISO 527 | 16.6 |
| 5 | Flexural Modulus Chord, 2 mm/min | Mpa | ISO 178 | 2945 |
| 6 | Flexural Strength, 2 mm/min | Mpa | ISO 178 | 54.3 |
| 7 | Notched Charpy Impact, 23° C. | KJ/m² | ISO 180 | 36.5 |
| 8 | Notched Charpy Impact, −30° C. | KJ/m² | ISO 180 | 18.2 |
| 9 | Hardness, Shore D | | ISO 2039 | 65 |
| 10 | Softness Rating, Grain CPM541 | excellent, | APNA Method | unacceptable |
| 11 | Softness Rating, Grain CPM518 | acceptable or | APNA Method | unacceptable |
| | | unacceptable | | |
| 12 | Multiaxial Impact, 6.7 m/s, 23° C. Energy to max load | J | ASTM D3763 | 9.6 (D) |
| 13 | Multiaxial Impact, 6.7 m/s, 0° C. Energy to max load | J | ASTM D3763 | 5.5 (D) |
| 14 | Multiaxial Impact, 6.7 m/s, −30° C. Energy to max load | J | ASTM D3763 | 6.2 (D)* |
| 15 | Number Average Glass Fiber Length | microns | APNA Method | 206.4 |

*indicates test specimen cracked, however cracks did not extend outside ring and test specimen did not shatter

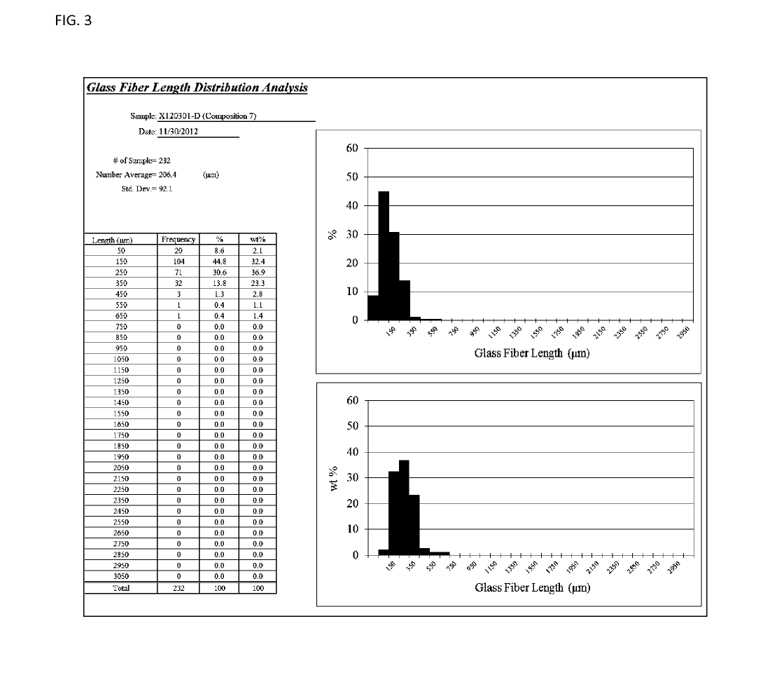

The detailed number average glass fiber length results are listed in FIG. 3.

Composition 8 was prepared by dry blending 69.5 wt % of the composition listed below as X121021-A with 30.5% of COMUSA LLC Funcster LR26YA8 material. Composition X121021-A is identical to Composition 7 disclosed. Composition X121021-A was prepared by melt mixing using a twin-screw extruder according to the scheme in FIG. 1. Composition X121021-A in weight percent of total composition, consists of the following:

| Material Supplier and Grade | | X121021- |
|---|---|---|
| Name | Material Description | A |
| Equistar Chemicals Hifax | Reactor TPO | 12.98 |
| CA138 | | |
| Equistar Chemicals Adflex | Reactor TPO | 31.97 |
| Q200F | | |
| Formosa Formolene 4100T | Homopolymer PP | 27.55 |
| Chemtura Polybond 3200 | Maleic Anhydride Grafted | 1.00 |
| | Polypropylene | |
| Standridge Color SSC22598 | Carbon Black Masterbatch, | 1.00 |
| | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 8 exhibited the following properties:

| | | | | 69.5% X121021-A + 30.5% |
|---|---|---|---|---|
| ITEM # | TEST DESCRIPTION | UNITS | TEST METHOD | COMUSA LLC LR26YA8 |
| 1 | Melt Flow Rate, 230° C./2.16 kg | g/10 min | ISO 1133 | 1.8 |
| 2 | Filler Content, 1500° F./10 minutes | % | ISO 3451 | 35.7 |
| 3 | Tensile Strength, 50 mm/min | Mpa | ISO 527 | 84.3 |
| 4 | Tensile Elongation at Break, 50 mm/min | % | ISO 527 | 2.9 |
| 5 | Flexural Modulus Chord, 2 mm/min | Mpa | ISO 178 | 5810 |
| 6 | Flexural Strength, 2 mm/min | Mpa | ISO 178 | 113 |
| 7 | Notched Charpy Impact, 23° C. | KJ/m² | ISO 180 | 31.1 |
| 8 | Notched Charpy Impact, −30° C. | KJ/m² | ISO 180 | 20.8 |
| 9 | Heat Deflection Temperature, 0.45 MPa | ° C. | ISO 75 | 160 |
| 10 | Hardness, Shore D | | ISO 2039 | 70 |
| 11 | Softness Rating, Nissan grain 424 | excellent, | APNA Method | acceptable |
| 12 | Softness Rating, Nissan grain 536 | acceptable or | APNA Method | acceptable |
| | | unacceptable | | |
| 13 | Multiaxial Impact, 6.7 m/s, −30° C. Energy to max load | J | ASTM D3763 | 7.8 (D)* |
| 14 | Number Average Glass Fiber Length | microns | APNA Method | 243.8 |

*indicates test specimen cracked, however cracks did not extend outside ring and test specimen did not shatter

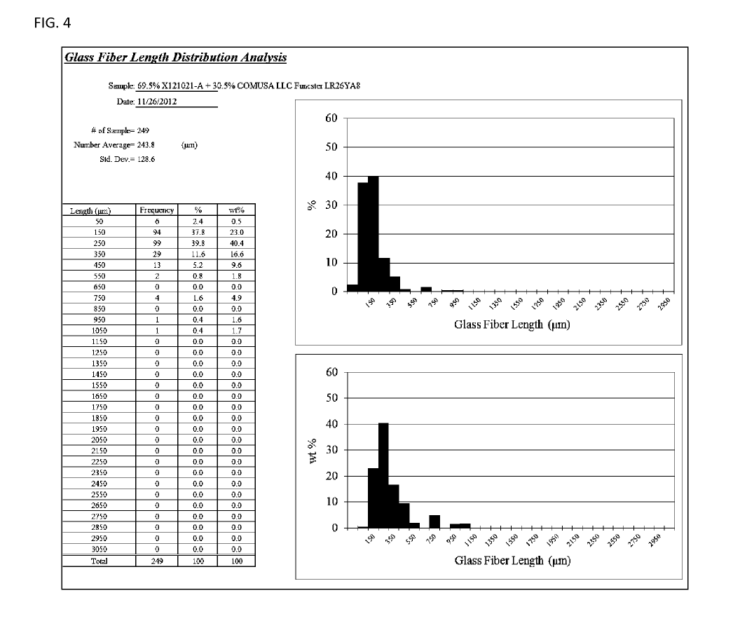

The detailed number average glass fiber length results are listed in FIG. 4.

Composition 9 was prepared by melt mixing using a twin-screw extruder according to the scheme in FIG. 1. The composition of 9, in weight percent of total composition, consists of the following:

| Material Supplier and Grade | | X120301- |
|---|---|---|
| Name | Material Description | E |
| Equistar Chemicals Hifax | Reactor TPO | 53.29 |
| CA10A | | |
| Dow Engage 8100 | Plastomer, Ethylene-Octene | 19.21 |
| | Copolymer | |
| Chemtura Polybond 3200 | Maleic Anhydride Grafted | 1.00 |
| | Polypropylene | |
| Standridge Color SSC22598 | Carbon Black Masterbatch, | 1.00 |
| | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 9 exhibited the following properties:

| ITEM # | TEST DESCRIPTION | UNITS | TEST METHOD | X120301-E |
|---|---|---|---|---|
| 1 | Melt Flow Rate, 230° C./2.16 kg | g/10 min | ISO 1133 | 0.5 |
| 2 | Filler Content, 1500° F./10 minutes | % | ISO 3451 | 25.2 |
| 3 | Tensile Strength, 5 mm/min | Mpa | ISO 527 | 16 |
| 4 | Tensile Elongation at Break, 5 mm/min | % | ISO 527 | 43.0 |
| 5 | Flexural Modulus Chord, 2 mm/min | Mpa | ISO 178 | 445 |
| 6 | Flexural Strength, 2 mm/min | Mpa | ISO 178 | 12.8 |
| 7 | Notched Charpy Impact, 23° C. | KJ/m² | ISO 180 | 56.0 |
| 8 | Notched Charpy Impact, −30° C. | KJ/m² | ISO 180 | 59.2 |
| 9 | Hardness, Shore D | | ISO 2039 | 40 |
| 10 | Softness Rating, Grain CPM541 | excellent, | APNA Method | excellent |
| 11 | Softness Rating, Grain CPM518 | acceptable or | APNA Method | excellent |
| | | unacceptable | | |
| 12 | Multiaxial Impact, 6.7 m/s, 23° C. Energy to max load | J | ASTM D3763 | 15.6 (D) |
| 13 | Multiaxial Impact, 6.7 m/s, 0° C. Energy to max load | J | ASTM D3763 | 15.0 (D) |
| 14 | Multiaxial Impact, 6.7 m/s, −30° C. Energy to max load | J | ASTM D3763 | 10.1 (D)* |

*indicates test specimen cracked, however cracks did not extend outside ring and test specimen did not shatter

Composition 10 was prepared by melt mixing using a twin-screw extruder according to the scheme in FIG. 1. The composition of 10, in weight percent of total composition, consists of the following:

| Material Supplier and Grade | | X120301- |
|---|---|---|
| Name | Material Description | F |
| Equistar Chemicals Hifax | Reactor TPO | 53.29 |
| CA10A | | |
| Braskem PP TR3350C | Random Copolymer PP | 11.96 |
| Dow Engage 8100 | Plastomer, Ethylene-Octene | 7.25 |
| | Copolymer | |
| Chemtura Polybond 3200 | Maleic Anhydride Grafted | 1.00 |
| | Polypropylene | |
| Standridge Color SSC22598 | Carbon Black Masterbatch, | 1.00 |
| | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 10 exhibited the following properties:

| ITEM # | TEST DESCRIPTION | UNITS | TEST METHOD | X120301-F |
|---|---|---|---|---|
| 1 | Melt Flow Rate, 230° C./2.16 kg | g/10 min | ISO 1133 | 0.7 |
| 2 | Filler Content, 1500° F./10 minutes | % | ISO 3451 | 25.2 |
| 3 | Tensile Strength, 5 mm/min | Mpa | ISO 527 | 22.6 |
| 4 | Tensile Elongation at Break, 5 mm/min | % | ISO 527 | 36.0 |
| 5 | Flexural Modulus Chord, 2 mm/min | Mpa | ISO 178 | 1037 |
| 6 | Flexural Strength, 2 mm/min | Mpa | ISO 178 | 21.5 |
| 7 | Notched Charpy Impact, 23° C. | KJ/m² | ISO 180 | 57.0 |
| 8 | Notched Charpy Impact, −30° C. | KJ/m² | ISO 180 | 46.2 |
| 9 | Hardness, Shore D | | ISO 2039 | 50 |
| 10 | Softness Rating, Grain CPM541 | excellent, | APNA Method | excellent |
| 11 | Softness Rating, Grain CPM518 | acceptable or | APNA Method | excellent |
| | | unacceptable | | |
| 12 | Multiaxial Impact, 6.7 m/s, 23° C. Energy to max load | J | ASTM D3763 | 14.9 (D) |
| 13 | Multiaxial Impact, 6.7 m/s, 0° C. Energy to max load | J | ASTM D3763 | 14.4 (D) |
| 14 | Multiaxial Impact, 6.7 m/s, −30° C. Energy to max load | J | ASTM D3763 | 8.5 (D)* |

*indicates test specimen cracked, however cracks did not extend outside ring and test specimen did not shatter

Composition 11 was prepared by melt mixing using a twin-screw extruder according to the scheme in FIG. 1. The composition of 11, in weight percent of total composition, consists of the following:

| Material Supplier and Grade | | X120301- |
|---|---|---|
| Name | Material Description | G |
| Equistar Chemicals Hifax | Reactor TPO | 31.97 |
| CA10A | | |
| Dow Engage 8100 | Plastomer, Ethylene-Octene | 19.21 |
| | Copolymer | |
| Braskem PP TR3350C | Random Copolymer PP | 21.32 |
| Chemtura Polybond 3200 | Maleic Anhydride Grafted | 1.00 |
| | Polypropylene | |
| Standridge Color SSC22598 | Carbon Black Masterbatch, | 1.00 |
| | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 11 exhibited the following properties:

| ITEM # | TEST DESCRIPTION | UNITS | TEST METHOD | X120301-G |
|---|---|---|---|---|
| 1 | Melt Flow Rate, 230° C./2.16 kg | g/10 min | ISO 1133 | 1.5 |
| 2 | Filler Content, 1500° F./10 minutes | % | ISO 3451 | 25.4 |
| 3 | Tensile Strength, 5 mm/min | Mpa | ISO 527 | 25.1 |
| 4 | Tensile Elongation at Break, 5 mm/min | % | ISO 527 | 28.6 |
| 5 | Flexural Modulus Chord, 2 mm/min | Mpa | ISO 178 | 1306 |
| 6 | Flexural Strength, 2 mm/min | Mpa | ISO 178 | 25.9 |
| 7 | Notched Charpy Impact, 23° C. | KJ/m² | ISO 180 | 60.1 |
| 8 | Notched Charpy Impact, −30° C. | KJ/m² | ISO 180 | 38.0 |
| 9 | Hardness, Shore D | | ISO 2039 | 55 |
| 10 | Softness Rating, Grain CPM541 | excellent | APNA Method | unacceptable |
| 11 | Softness Rating, Grain CPM518 | acceptable or | APNA Method | unacceptable |
| | | unacceptable | | |
| 12 | Multiaxial Impact, 6.7 m/s, 23° C. Energy to max load | J | ASTM D3763 | 14.8 (D) |
| 13 | Multiaxial Impact, 6.7 m/s, 0° C. Energy to max load | J | ASTM D3763 | 11.5 (D) |
| 14 | Multiaxial Impact, 6.7 m/s, −30° C. Energy to max load | J | ASTM D3763 | 7.6 (D)* |

*indicates test specimen cracked, however cracks did not extend outside ring and test specimen did not shatter

Composition 12 was prepared by melt mixing using a twin-screw extruder according to the scheme in FIG. 1. The composition of 12, in weight percent of total composition, consists of the following:

| Material Supplier and | | |
|---|---|---|
| Grade Name | Material Description | X120301-H |
| Equistar Chemicals Hifax | Reactor TPO | 31.97 |
| CA10A | | |
| Dow Engage 8100 | Plastomer, Ethylene-Octene | 7.25 |
| | Copolymer | |
| Braskem PP TR3350C | Random Copolymer PP | 33.28 |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 12 exhibited the following properties:

| ITEM # | TEST DESCRIPTION | UNITS | TEST METHOD | X120301-H |
|---|---|---|---|---|
| 1 | Melt Flow Rate, 230° C./2.16 kg | g/10 min | ISO 1133 | 2.0 |
| 2 | Filler Content, 1500° F./10 minutes | % | ISO 3451 | 25.5 |
| 3 | Tensile Strength, 5 mm/min | Mpa | ISO 527 | 33.1 |
| 4 | Tensile Elongation at Break, 5 mm/min | % | ISO 527 | 23.0 |
| 5 | Flexural Modulus Chord, 2 mm/min | Mpa | ISO 178 | 2187 |
| 6 | Flexural Strength, 2 mm/min | Mpa | ISO 178 | 39.3 |
| 7 | Notched Charpy Impact, 23° C. | KJ/m² | ISO 180 | 43.5 |
| 8 | Notched Charpy Impact, −30° C. | KJ/m² | ISO 180 | 18.5 |
| 9 | Hardness, Shore D | | ISO 2039 | 60 |
| 10 | Softness Rating, Grain CPM541 | excellent, | APNA Method | unacceptable |
| 11 | Softness Rating, Grain CPM518 | acceptable or | APNA Method | unacceptable |
| | | unacceptable | | |
| 12 | Multiaxial Impact, 6.7 m/s, 23° C. Energy to max load | J | ASTM D3763 | 11.4 (D) |
| 13 | Multiaxial Impact, 6.7 m/s, 0° C. Energy to max load | J | ASTM D3763 | 7.3 (D) |
| 14 | Multiaxial Impact, 6.7 m/s, −30° C. Energy to max load | J | ASTM D3763 | 8.5 (D)* |

*indicates test specimen cracked, however cracks did not extend outside ring and test specimen did not shatter

Composition 13 was prepared by melt mixing using a twin-screw extruder according to the scheme in FIG. 1. The composition of 13, in weight percent of total composition, consists of the following:

| Material Supplier and | | |
|---|---|---|
| Grade Name | Material Description | X120621-A |
| Equistar Chemicals Adflex | Reactor TPO | 53.29 |
| Q200F | | |
| Dow Engage 8100 | Plastomer, Ethylene-Octene | 19.21 |
| | Copolymer | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC1313 | Micron diameter short | 25.00 |
| 738 3/16″ Thermoflow | glass fiber for PP | |
| Series | | |

Composition 13 exhibited the following properties:

| ITEM # | TEST DESCRIPTION | UNITS | TEST METHOD | X120621-A |
|---|---|---|---|---|
| 1 | Melt Flow Rate, 230° C./2.16 kg | g/10 min | ISO 1133 | 0.6 |
| 2 | Filler Content, 1500° F./10 minutes | % | ISO 3451 | 24.7 |
| 3 | Tensile Strength, 5 mm/min | Mpa | ISO 527 | 17.7 |
| 4 | Tensile Elongation at Break, 5 mm/min | % | ISO 527 | 38.3 |
| 5 | Flexural Modulus Chord, 2 mm/min | Mpa | ISO 178 | 550 |
| 6 | Flexural Strength, 2 mm/min | Mpa | ISO 178 | 15.1 |
| 7 | Notched Charpy Impact, 23° C. | KJ/m² | ISO 180 | 67.2 |
| 8 | Notched Charpy Impact, −30° C. | KJ/m² | ISO 180 | 42.8 |
| 9 | Heat Deflection Temperature, 0.45 MPa | ° C. | ISO 75 | 62 |
| 10 | Hardness, Shore D | | ISO 2039 | 40 |
| 11 | Softness Rating, Grain CPM541 | excellent, | APNA Method | excellent |
| 12 | Softness Rating, Grain CPM518 | acceptable or | APNA Method | excellent |
| | | unacceptable | | |
| 13 | Multiaxial Impact, 6.7 m/s, 23° C. Energy to max load | J | ASTM D3763 | 13.4 (D) |
| 14 | Multiaxial Impact, 6.7 m/s, −30° C. Energy to max load | J | ASTM D3763 | 10.5 (D)* |

*indicates test specimen cracked, however cracks did not extend outside ring and test specimen did not shatter

Composition 14 was prepared by melt mixing using a twin-screw extruder according to the scheme in FIG. 1. The composition of 14, in weight percent of total composition, consists of the following:

| Material Supplier and | | |
|---|---|---|
| Grade Name | Material Description | X120621-B |
| Equistar Chemicals Adflex | Reactor TPO | 66.50 |
| Q200F | | |
| Dow Engage 8100 | Plastomer, Ethylene-Octene | 24.00 |
| | Copolymer | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 7.00 |
| 3/16″ Thermoflow Series | glass fiber for PP | |

Composition 14 exhibited the following properties:

| ITEM # | TEST DESCRIPTION | UNITS | TEST METHOD | X120621-B |
|---|---|---|---|---|
| 1 | Melt Flow Rate, 230° C./2.16 kg | g/10 min | ISO 1133 | 0.8 |
| 2 | Filler Content, 1500° F./10 minutes | % | ISO 3451 | 7.1 |
| 3 | Tensile Strength, 5 mm/min | Mpa | ISO 527 | 10.3 |
| 4 | Tensile Elongation at Break, 5 mm/min | % | ISO 527 | 281.7 |
| 5 | Flexural Modulus Chord, 2 mm/min | Mpa | ISO 178 | 227 |
| 6 | Flexural Strength, 2 mm/min | Mpa | ISO 178 | 8.1 |
| 7 | Notched Charpy Impact, 23° C. | KJ/m² | ISO 180 | 49.7 |
| 8 | Notched Charpy Impact, −30° C. | KJ/m² | ISO 180 | 66.4 |
| 9 | Heat Deflection Temperature, 0.45 MPa | ° C. | ISO 75 | 44 |
| 10 | Hardness, Shore D | | ISO 2039 | 40 |
| 11 | Softness Rating, Grain CPM541 | excellent | APNA Method | excellent |
| 12 | Softness Rating, Grain CPM518 | acceptable or | APNA Method | excellent |
| | | unacceptable | | |
| 13 | Multiaxial Impact, 6.7 m/s, 23° C. Energy to max load | J | ASTM D3763 | 13.0 (D) |
| 14 | Multiaxial Impact, 6.7 m/s, −30° C. Energy to max load | J | ASTM D3763 | 12.0 (D)* |
| 15 | Number Average Glass Fiber Length | microns | APNA Method | 203.4 |

*indicates test specimen cracked, however cracks did not extend outside ring and test specimen did not shatter

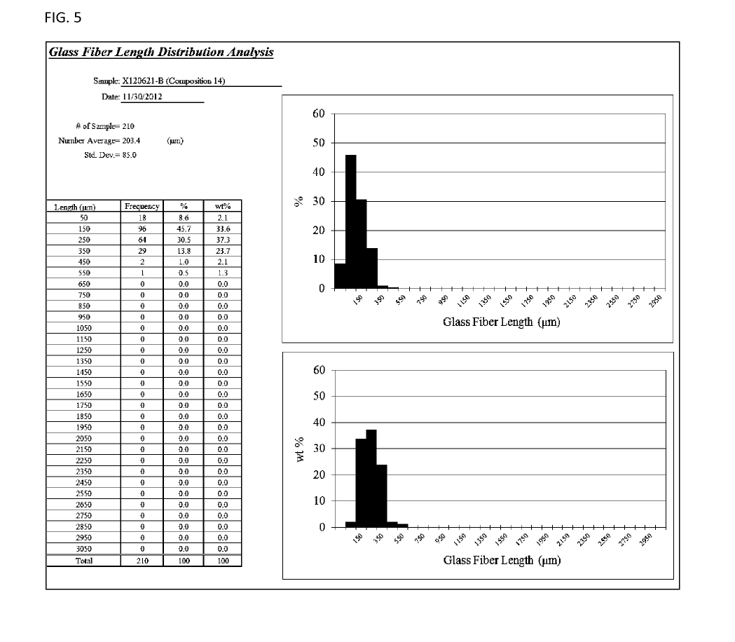

The detailed number average glass fiber length results are listed in FIG. 5.

Composition 15 was prepared by dry blending 89.0 weight % of the composition listed below as X121021-B with 11.0 weight % of COMUSA LLC Funcster LR26YA8 material. Composition X121021-B is identical to Composition 14 disclosed. Composition X121021-B was prepared by melt mixing using a twin-screw extruder according to the scheme in FIG. 1. Composition X121021-B in weight percent of total composition, consists of the following:

| Material Supplier and | | |
|---|---|---|
| Grade Name | Material Description | X121021-B |
| Equistar Chemicals Adflex | Reactor TPO | 66.50 |
| Q200F | | |
| Dow Engage 8100 | Plastomer, Ethylene-Octene | 24.00 |
| | Copolymer | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 7.00 |
| 3/16″ Thermoflow Series | glass fiber for PP | |

Composition 15 exhibited the following properties:

| | | | | 89% X121021-B + 11% |
|---|---|---|---|---|
| ITEM # | TEST DESCRIPTION | UNITS | TEST METHOD | COMUSA LLC LR26YA8 |
| 1 | Melt Flow Rate, 230° C./2.16 kg | g/10 min | ISO 1133 | 0.6 |
| 2 | Filler Content, 1500° F./10 minutes | % | ISO 3451 | 14.3 |
| 3 | Tensile Strength, 50 mm/min | Mpa | ISO 527 | 23.9 |
| 4 | Tensile Elongation at Break, 50 mm/min | % | ISO 527 | 22.5 |
| 5 | Flexural Modulus Chord, 2 mm/min | Mpa | ISO 178 | 586 |
| 6 | Flexural Strength, 2 mm/min | Mpa | ISO 178 | 17.1 |
| 7 | Notched Charpy Impact, 23° C. | KJ/m² | ISO 180 | 62.1 |
| 8 | Notched Charpy Impact, −30° C. | KJ/m² | ISO 180 | 42.3 |
| 9 | Heat Deflection Temperature, 0.45 MPa | ° C. | ISO 75 | 61 |
| 10 | Hardness, Shore D | | ISO 2039 | 67 |
| 11 | Softness Rating, Nissan grain 424 | excellent, | APNA Method | excellent |
| 12 | Softness Rating, Nissan grain 536 | acceptable or | APNA Method | excellent |
| | | unacceptable | | |
| 13 | Multiaxial Impact, 6.7 m/s, −30° C. Energy to max load | J | ASTM D3763 | 8.2 (D)* |
| 14 | Number Average Glass Fiber Length | microns | APNA Method | 263.8 |

*indicates test specimen cracked, however cracks did not extend outside ring and test specimen did not shatter

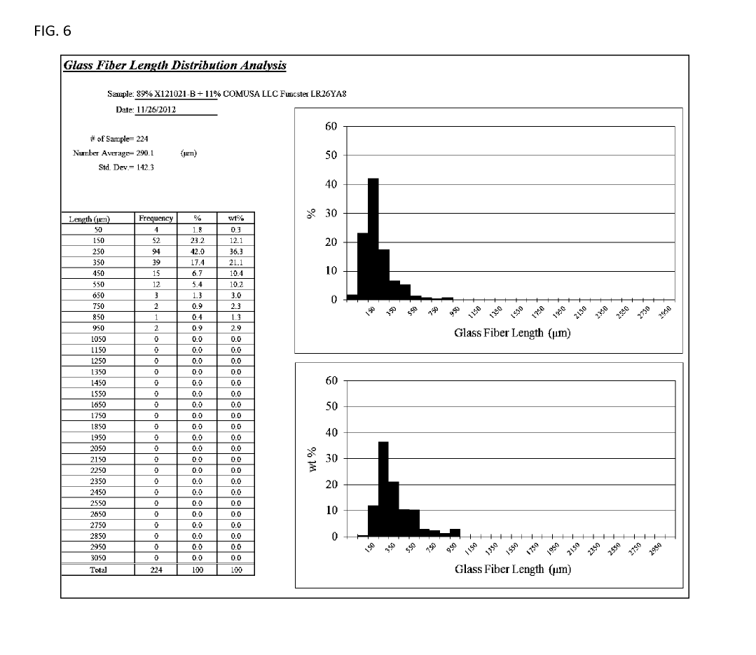

The detailed number average glass fiber length results are listed in FIG. 6.

Composition 16 was prepared by melt mixing using a twin-screw extruder according to the scheme in FIG. 1. The composition of 16, in weight percent of total composition, consists of the following:

| Material Supplier and | | |
|---|---|---|
| Grade Name | Material Description | X120621-C |
| Dow Developmental | Plastomer, Propylene- | 35.88 |
| Elastomer DE4301.05 | Ethylene Copolymer | |
| Equistar Chemicals Adflex | Reactor TPO | 27.19 |
| Q200F | | |
| Dow Engage 8100 | Plastomer, Ethylene-Octene | 9.43 |
| | Copolymer | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 16 exhibited the following properties:

| ITEM # | TEST DESCRIPTION | UNITS | TEST METHOD | X120621-C |
|---|---|---|---|---|
| 1 | Melt Flow Rate, 230° C./2.16 kg | g/10 min | ISO 1133 | 2.1 |
| 2 | Filler Content, 1500° F./10 minutes | % | ISO 3451 | 24.8 |
| 3 | Tensile Strength, 5 mm/min | Mpa | ISO 527 | 20.0 |
| 4 | Tensile Elongation at Break, 5 mm/min | % | ISO 527 | 47.9 |
| 5 | Flexural Modulus Chord, 2 mm/min | Mpa | ISO 178 | 461 |
| 6 | Flexural Strength, 2 mm/min | Mpa | ISO 178 | 14.7 |
| 7 | Notched Charpy Impact, 23° C. | KJ/m² | ISO 180 | 53.0 |
| 8 | Notched Charpy Impact, −30° C. | KJ/m² | ISO 180 | 22.0 |
| 9 | Heat Deflection Temperature, 0.45 MPa | ° C. | ISO 75 | 49 |
| 10 | Hardness, Shore D | | ISO 2039 | 45 |
| 11 | Softness Rating, Grain CPM541 | excellent | APNA Method | excellent |
| 12 | Softness Rating, Grain CPM518 | acceptable or | APNA Method | excellent |
| | | unacceptable | | |
| 13 | Multiaxial Impact, 6.7 m/s, 23° C. Energy to max load | J | ASTM D3763 | 9.2 (D) |
| 14 | Multiaxial Impact, 6.7 m/s, −30° C. Energy to max load | J | ASTM D3763 | 7.0 (B) |

Composition 17 was prepared by melt mixing using a twin-screw extruder according to the scheme in FIG. 1. The composition of 17, in weight percent of total composition, consists of the following:

| Material Supplier and | | |
|---|---|---|
| Grade Name | Material Description | X120621-D |
| Kraton G1652M | polystyrene-block- | 7.00 |
| | poly(ethylene-co-butylene)- | |
| | block-polystyrene (SEBS) | |
| | triblock thermoplastic | |
| | elastomer | |
| Equistar Chemicals Adflex | Reactor TPO | 48.14 |
| Q200F | | |
| Dow Engage 8100 | Plastomer, Ethylene-Octene | 17.36 |
| | Copolymer | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 17 exhibited the following properties:

| ITEM # | TEST DESCRIPTION | UNITS | TEST METHOD | X120621-D |
|---|---|---|---|---|
| 1 | Melt Flow Rate, 230° C./2.16 kg | g/10 min | ISO 1133 | 0.7 |
| 2 | Filler Content, 1500° F./10 minutes | % | ISO 3451 | 24.4 |
| 3 | Tensile Strength, 5 mm/min | Mpa | ISO 527 | 18.0 |
| 4 | Tensile Elongation at Break, 5 mm/min | % | ISO 527 | 52.4 |
| 5 | Flexural Modulus Chord, 2 mm/min | Mpa | ISO 178 | 486 |
| 6 | Flexural Strength, 2 mm/min | Mpa | ISO 178 | 14.3 |
| 7 | Notched Charpy Impact, 23° C. | KJ/m² | ISO 180 | 61.6 |
| 8 | Notched Charpy Impact, −30° C. | KJ/m² | ISO 180 | 10.3 |
| 9 | Heat Deflection Temperature, 0.45 MPa | ° C. | ISO 75 | 57 |
| 10 | Hardness, Shore D | | ISO 2039 | 40 |
| 11 | Softness Rating, Grain CPM541 | excellent, | APNA Method | excellent |
| 12 | Softness Rating, Grain CPM518 | acceptable or | APNA Method | excellent |
| | | unacceptable | | |
| 13 | Multiaxial Impact, 6.7 m/s, 23° C. Energy to max load | J | ASTM D3763 | 7.0 (D) |
| 14 | Multiaxial Impact, 6.7 m/s, −30° C. Energy to max load | J | ASTM D3763 | 15.6 (D)* |

*indicates test specimen cracked, however cracks did not extend outside ring and test specimen did not shatter

Composition 18 was prepared by melt mixing using a twin-screw extruder according to the scheme in FIG. 1. The composition of 18, in weight percent of total composition, consists of the following:

| Material Supplier and | | |
|---|---|---|
| Grade Name | Material Description | X120621-E |
| Equistar Chemicals Adflex | Reactor TPO | 47.40 |
| Q200F | | |
| Dow Engage 8100 | Plastomer, Ethylene-Octene | 17.10 |
| | Copolymer | |
| Honeywell H8202NL | Prime PA6 | 7.00 |
| Chemtura Polybond 3200 | Maleic Anhydride Grafted | 2.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 18 exhibited the following properties:

| ITEM # | TEST DESCRIPTION | UNITS | TEST METHOD | X120621-E |
|---|---|---|---|---|
| 1 | Melt Flow Rate, 230° C./2.16 kg | g/10 min | ISO 1133 | 0.7 |
| 2 | Filler Content, 1500° F./10 minutes | % | ISO 3451 | 24.1 |
| 3 | Tensile Strength, 5 mm/min | Mpa | ISO 527 | 18.9 |
| 4 | Tensile Elongation at Break, 5 mm/min | % | ISO 527 | 52.1 |
| 5 | Flexural Modulus Chord, 2 mm/min | Mpa | ISO 178 | 628 |
| 6 | Flexural Strength, 2 mm/min | Mpa | ISO 178 | 16.6 |
| 7 | Notched Charpy Impact, 23° C. | KJ/m² | ISO 180 | 65.2 |
| 8 | Notched Charpy Impact, −30° C. | KJ/m² | ISO 180 | 46.8 |
| 9 | Heat Deflection Temperature, 0.45 MPa | ° C. | ISO 75 | 57 |
| 10 | Hardness, Shore D | | ISO 2039 | 45 |
| 11 | Softness Rating, Grain CPM541 | excellent, | APNA Method | excellent |
| 12 | Softness Rating, Grain CPM518 | acceptable or | APNA Method | excellent |
| | | unacceptable | | |
| 13 | Multiaxial Impact, 6.7 m/s, 23° C. Energy to max load | J | ASTM D3763 | 2.9 (D) |
| 14 | Multiaxial Impact, 6.7 m/s, −30° C. Energy to max load | J | ASTM D3763 | 16.9 (D)* |

*indicates test specimen cracked, however cracks did not extend outside ring and test specimen did not shatter

Composition 19 was prepared by melt mixing using a twin-screw extruder according to the scheme in FIG. 1. The composition of 19, in weight percent of total composition, consists of the following:

| Material Supplier and | | |
|---|---|---|
| Grade Name | Material Description | X120908-A |
| Equistar Chemicals Adflex | Reactor TPO | 24.96 |
| Q200F | | |
| Dow Engage 8100 | Plastomer, Ethylene-Octene | 8.66 |
| | Copolymer | |
| Dow Developmental | Plastomer, Propylene- | 35.88 |
| Elastomer DE4301.05 | Ethylene Copolymer | |
| Evonik Tegomer H-Si | Wax type siloxane-co- | 3.00 |
| 6440P | polyester anti-scratch | |
| | additive | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 738 | 13 Micron diameter short | 25.00 |
| 3/16″ Thermoflow Series | glass fiber for PP | |

Composition 19 exhibited the following properties:

| ITEM # | TEST DESCRIPTION | UNITS | TEST METHOD | X120908-A |
|---|---|---|---|---|
| 1 | Melt Flow Rate, 230° C./2.16 kg | g/10 min | ISO 1133 | 4.0 |
| 2 | Filler Content, 1500° F./10 minutes | % | ISO 3451 | 27.3 |
| 3 | Tensile Strength, 5 mm/min | Mpa | ISO 527 | 18.2 |
| 4 | Tensile Elongation at Break, 5 mm/min | % | ISO 527 | 33.6 |
| 5 | Flexural Modulus Chord, 2 mm/min | Mpa | ISO 178 | 537 |
| 6 | Flexural Strength, 2 mm/min | Mpa | ISO 178 | 16.4 |
| 7 | Notched Charpy Impact, 23° C. | KJ/m² | ISO 180 | 51.4 |
| 8 | Notched Charpy Impact, −30° C. | KJ/m² | ISO 180 | 14.7 |
| 9 | Hardness, Shore D | | ISO 2039 | 48 |
| 10 | Softness Rating, Grain CPM541 | excellent, | APNA Method | excellent |
| 11 | Softness Rating, Grain CPM518 | acceptable or | APNA Method | acceptable |
| | | unacceptable | | |
| 12 | Multiaxial Impact, 6.7 m/s, 23° C. Energy to max load | J | ASTM D3763 | 10.1 (D) |
| 13 | Multiaxial Impact, 6.7 m/s, −30° C. Energy to max load | J | ASTM D3763 | 5.7 (B) |

Composition 20 was prepared by melt mixing using a twin-screw extruder according to the scheme in FIG. 1. The composition of 20, in weight percent of total composition, consists of the following:

| Material Supplier and | | |
|---|---|---|
| Grade Name | Material Description | X120908-B |
| Equistar Chemicals | Reactor TPO | 24.96 |
| Adflex Q200F | | |
| Dow Engage 8100 | Plastomer, Ethylene-Octene | 8.66 |
| | Copolymer | |
| Kraton G4609H | White mineral oil extended | 35.88 |
| | polystyrene-block- | |
| | poly(ethylene-co-butylene)- | |
| | block-polystyrene (SEBS) | |
| | triblock thermoplastic | |
| | elastomer | |
| Evonik Tegomer H-Si | Wax type siloxane-co- | 3.00 |
| 6440P | polyester anti-scratch | |
| | additive | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals | Homopolymer PP flake | 0.20 |
| Profax 6301 | | |
| Johns Manville | 13 Micron diameter short | 25.00 |
| EC13 738 3/16″ | glass fiber for PP | |
| Thermoflow Series | | |

Composition 20 exhibited the following properties:

| ITEM # | TEST DESCRIPTION | UNITS | TEST METHOD | X120908-B |
|---|---|---|---|---|
| 1 | Melt Flow Rate, 230° C./2.16 kg | g/10 min | ISO 1133 | 0.5 |
| 2 | Filler Content, 1500° F./10 minutes | % | ISO 3451 | 26.5 |
| 3 | Tensile Strength, 5 mm/min | Mpa | ISO 527 | 11.3 |
| 4 | Tensile Elongation at Break, 5 mm/min | % | ISO 527 | 36.1 |
| 5 | Flexural Modulus Chord, 2 mm/min | Mpa | ISO 178 | 246 |
| 6 | Flexural Strength, 2 mm/min | Mpa | ISO 178 | 8.1 |
| 7 | Notched Charpy Impact, 23° C. | KJ/m² | ISO 180 | 37.5 |
| 8 | Notched Charpy Impact, −30° C. | KJ/m² | ISO 180 | 62.4 |
| 9 | Hardness, Shore D | | ISO 2039 | 34 |
| 10 | Softness Rating, Grain CPM541 | excellent, | APNA Method | acceptable |
| 11 | Softness Rating, Grain CPM518 | acceptable or | APNA Method | acceptable |
| | | unacceptable | | |
| 12 | Multiaxial Impact, 6.7 m/s, 23° C. Energy to max load | J | ASTM D3763 | 8.4 (D) |
| 13 | Multiaxial Impact, 6.7 m/s, −30° C. Energy to max load | J | ASTM D3763 | 9.8 (D)* |

*indicates test specimen cracked, however cracks did not extend outside ring and test specimen did not shatter

Composition 21 was prepared by melt mixing using a twin-screw extruder according to the scheme in FIG. 1. The composition of 21, in weight percent of total composition, consists of the following:

| Material Supplier and | | |
|---|---|---|
| Grade Name | Material Description | X120908-C |
| Equistar Chemicals | Reactor TPO | 24.96 |
| Adflex Q200F | | |
| Dow Engage 8100 | Plastomer, Ethylene-Octene | 8.66 |
| | Copolymer | |
| Dow Infuse 9807 | Olefinic block copolymer | 35.88 |
| Evonik Tegomer | Wax type siloxane-co- | 3.00 |
| H-Si 6440P | polyester anti-scratch | |
| | additive | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals | Homopolymer PP flake | 0.20 |
| Profax 6301 | | |
| Johns Manville EC13 | 13 Micron diameter short | 25.00 |
| 738 3/16″ Thermoflow | glass fiber for PP | |
| Series | | |

Composition 21 exhibited the following properties:

| ITEM # | TEST DESCRIPTION | UNITS | TEST METHOD | X120908-C |
|---|---|---|---|---|
| 1 | Melt Flow Rate, 230° C./2.16 kg | g/10 min | ISO 1133 | 5.6 |
| 2 | Filler Content, 1500° F./10 minutes | % | ISO 3451 | 25.1 |
| 3 | Tensile Strength, 5 mm/min | Mpa | ISO 527 | 5.9 |
| 4 | Tensile Elongation at Break, 5 mm/min | % | ISO 527 | 130.3 |
| 5 | Flexural Modulus Chord, 2 mm/min | Mpa | ISO 178 | 182 |
| 6 | Flexural Strength, 2 mm/min | Mpa | ISO 178 | 5.8 |
| 7 | Notched Charpy Impact, 23° C. | KJ/m² | ISO 180 | 38.7 |
| 8 | Notched Charpy Impact, −30° C. | KJ/m² | ISO 180 | 52.4 |
| 9 | Hardness, Shore D | | ISO 2039 | 30 |
| 10 | Softness Rating, Grain CPM541 | excellent, | APNA Method | excellent |
| 11 | Softness Rating, Grain CPM518 | acceptable or | APNA Method | excellent |
| | | unacceptable | | |
| 12 | Multiaxial Impact, 6.7 m/s, 23° C. Energy to max load | J | ASTM D3763 | 8.2 (D) |
| 13 | Multiaxial Impact, 6.7 m/s, −30° C. Energy to max load | J | ASTM D3763 | 7.5 (D)* |

*indicates test specimen cracked, however cracks did not extend outside ring and test specimen did not shatter

Composition 22 was prepared by melt mixing using a twin-screw extruder according to the scheme in FIG. 1. The composition of 22, in weight percent of total composition, consists of the following:

| Material Supplier and | | |
|---|---|---|
| Grade Name | Material Description | X120908-D |
| Equistar Chemicals | Reactor TPO | 24.96 |
| Adflex Q200F | | |
| Dow Engage 8100 | Plastomer, Ethylene-Octene | 8.66 |
| | Copolymer | |
| Dow Infuse 9807 | Olefinic block copolymer | 35.88 |
| Evonik Tegomer H-Si | Wax type siloxane-co- | 3.00 |
| 6440P | polyester anti-scratch | |
| | additive | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals | Homopolymer PP flake | 0.20 |
| Profax 6301 | | |
| Johns Manville EC13 738 | 13 Micron diameter short | 25.00 |
| 3/16″ Thermoflow | glass fiber for PP | |
| Series | | |

Composition 22 exhibited the following properties:

| ITEM # | TEST DESCRIPTION | UNITS | TEST METHOD | X120908-D |
|---|---|---|---|---|
| 1 | Melt Flow Rate, 230° C./2.16 kg | g/10 min | ISO 1133 | 5.4 |
| 2 | Filler Content, 1500° F./10 minutes | % | ISO 3451 | 23.8 |
| 3 | Tensile Strength, 5 mm/min | Mpa | ISO 527 | 9.1 |
| 4 | Tensile Elongation at Break, 5 mm/min | % | ISO 527 | 51.5 |
| 5 | Flexural Modulus Chord, 2 mm/min | Mpa | ISO 178 | 375 |
| 6 | Flexural Strength, 2 mm/min | Mpa | ISO 178 | 9.7 |
| 7 | Notched Charpy Impact, 23° C. | KJ/m² | ISO 180 | 56.6 |
| 8 | Notched Charpy Impact, −30° C. | KJ/m² | ISO 180 | 56.3 |
| 9 | Hardness, Shore D | | ISO 2039 | 38 |
| 10 | Softness Rating, Grain CPM541 | excellent, | APNA Method | excellent |
| 11 | Softness Rating, Grain CPM518 | acceptable or | APNA Method | excellent |
| | | unacceptable | | |
| 12 | Multiaxial Impact, 6.7 m/s, 23° C. Energy to max load | J | ASTM D3763 | 10.8 (D) |
| 13 | Multiaxial Impact, 6.7 m/s, −30° C. Energy to max load | J | ASTM D3763 | 9.3 (D)* |
| 14 | Number Average Glass Fiber Length | microns | APNA Method | 216.2 |

*indicates test specimen cracked, however cracks did not extend outside ring and test specimen did not shatter

Composition 23 was prepared by dry blending 69.5 weight % of the composition listed below as X121021-C with 30.5 weight % of COMUSA LLC Funcster LR26YA8 material. Composition X121021-C is identical to Composition 22 disclosed. Composition X121021-C was prepared by melt mixing using a twin-screw extruder according to the scheme in FIG. 1. Composition X121021-C in weight percent of total composition, consists of the following:

| Material Supplier and | | |
|---|---|---|
| Grade Name | Material Description | X121021-C |
| Equistar Chemicals Adflex | Reactor TPO | 24.96 |
| Q200F | | |
| Dow Engage 8100 | Plastomer, Ethylene-Octene | 8.66 |
| | Copolymer | |
| Dow Infuse 9807 | Olefinic block copolymer | 35.88 |
| Evonik Tegomer H-Si | Wax type siloxane-co- | 3.00 |
| 6440P | polyester anti-scratch | |
| | additive | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals | Homopolymer PP flake | 0.20 |
| Profax 6301 | | |
| Johns Manville EC13 | 13 Micron diameter short | 25.00 |
| 738 3/16″ Thermoflow | glass fiber for PP | |
| Series | | |

Composition 23 exhibited the following properties:

| | | | | 69.5% X121021-C + 30.5% |
|---|---|---|---|---|
| ITEM # | TEST DESCRIPTION | UNITS | TEST METHOD | COMUSA LLC LR26YA8 |
| 1 | Melt Flow Rate, 230° C./2.16 kg | g/10 min | ISO 1133 | 2.0 |
| 2 | Filler Content, 1500° F./10 minutes | % | ISO 3451 | 37.9 |
| 3 | Tensile Strength, 50 mm/min | Mpa | ISO 527 | 39.0 |
| 4 | Tensile Elongation at Break, 50 mm/min | % | ISO 527 | 7.0 |
| 5 | Flexural Modulus Chord, 2 mm/min | Mpa | ISO 178 | 2496 |
| 6 | Flexural Strength, 2 mm/min | Mpa | ISO 178 | 72.8 |
| 7 | Notched Charpy Impact, 23° C. | KJ/m² | ISO 180 | 72.8 |
| 8 | Notched Charpy Impact, −30° C. | KJ/m² | ISO 180 | 48.7 |
| 9 | Heat Deflection Temperature, 0.45 MPa | ° C. | ISO 75 | 127 |
| 10 | Hardness, Shore D | | ISO 2039 | 45 |
| 11 | Softness Rating, Nissan grain 424 | excellent, | APNA Method | excellent |
| 12 | Softness Rating, Nissan grain 536 | acceptable or | APNA Method | excellent |
| | | unacceptable | | |
| 13 | Multiaxial Impact, 6.7 m/s, −30° C. Energy to max load | J | ASTM D3763 | 6.9 (D)* |
| 14 | Number Average Glass Fiber Length | microns | APNA Method | 263.8 |

*indicates test specimen cracked, however cracks did not extend outside ring and test specimen did not shatter

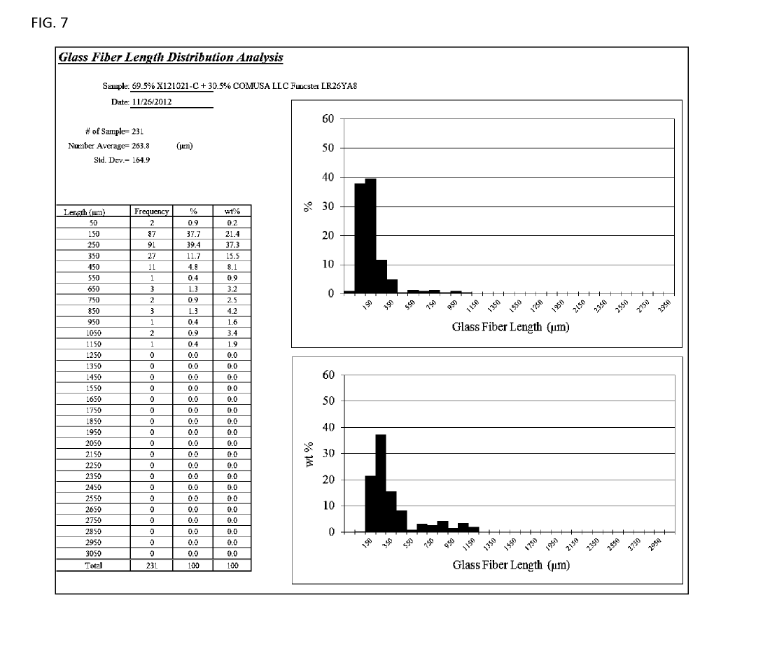

The detailed number average glass fiber length results are listed in FIG. 7.

Composition 24 was prepared by melt mixing using a twin-screw extruder according to the scheme in FIG. 1. The composition of 24, in weight percent of total composition, consists of the following:

| Material Supplier and | | |
|---|---|---|
| Grade Name | Material Description | X120908-E |
| Equistar Chemicals Adflex | Reactor TPO | 33.20 |
| Q200F | | |
| Dow Engage 8100 | Plastomer, Ethylene-Octene | 11.50 |
| | Copolymer | |
| Dow Developmental | Plastomer, Propylene- | 42.80 |
| Elastomer DE4301.05 | Ethylene Copolymer | |
| Evonik Tegomer H-Si | Wax type siloxane-co- | 3.00 |
| 6440P | polyester anti-scratch | |
| | additive | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 | 13 Micron diameter short | 7.00 |
| 738 3/16″ Thermoflow | glass fiber for PP | |
| Series | | |

Composition 24 exhibited the following properties:

| ITEM # | TEST DESCRIPTION | UNITS | TEST METHOD | X120908-E |
|---|---|---|---|---|
| 1 | Melt Flow Rate, 230° C./2.16 kg | g/10 min | ISO 1133 | 4.2 |
| 2 | Filler Content, 1500° F./10 minutes | % | ISO 3451 | 7.6 |
| 3 | Tensile Strength, 5 mm/min | Mpa | ISO 527 | 8.4 |
| 4 | Tensile Elongation at Break, 5 mm/min | % | ISO 527 | 283.6 |
| 5 | Flexural Modulus Chord, 2 mm/min | Mpa | ISO 178 | 170 |
| 6 | Flexural Strength, 2 mm/min | Mpa | ISO 178 | 6.8 |
| 7 | Notched Charpy Impact, 23° C. | KJ/m² | ISO 180 | 38.9 |
| 8 | Notched Charpy Impact, −30° C. | KJ/m² | ISO 180 | 40.2 |
| 9 | Hardness, Shore D | | ISO 2039 | 38 |
| 10 | Softness Rating, Grain CPM541 | excellent, | APNA Method | acceptable |
| 11 | Softness Rating, Grain CPM518 | acceptable or | APNA Method | acceptable |
| | | unacceptable | | |
| 12 | Multiaxial Impact, 6.7 m/s, 23° C. Energy to max load | J | ASTM D3763 | 12.8 (D) |
| 13 | Multiaxial Impact, 6.7 m/s, −30° C. Energy to max load | J | ASTM D3763 | 10.5 (B) |

*indicates test specimen cracked, however cracks did not extend outside ring and test specimen did not shatter

Composition 25 was prepared by melt mixing using a twin-screw extruder according to the scheme in FIG. 1. The composition of 25, in weight percent of total composition, consists of the following:

| Material Supplier and | | |
|---|---|---|
| Grade Name | Material Description | X120908-F |
| Equistar Chemicals Adflex | Reactor TPO | 33.20 |
| Q200F | | |
| Dow Engage 8100 | Plastomer, Ethylene-Octene | 11.50 |
| | Copolymer | |
| Dow Developmental | Plastomer, Propylene- | 21.40 |
| Elastomer DE4301.05 | Ethylene Copolymer | |
| Kraton G4609H | White mineral oil extended | 21.40 |
| | polystyrene-block- | |
| | poly(ethylene-co-butylene)- | |
| | block-polystyrene (SEBS) | |
| | triblock thermoplastic | |
| | elastomer | |
| Evonik Tegomer H-Si | Wax type siloxane-co- | 3.00 |
| 6440P | polyester anti-scratch | |
| | additive | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 | 13 Micron diameter short | 7.00 |
| 738 3/16″ Thermoflow | glass fiber for PP | |
| Series | | |

Composition 26 exhibited the following properties:

| ITEM # | TEST DESCRIPTION | UNITS | TEST METHOD | X120908-F |
|---|---|---|---|---|
| 1 | Melt Flow Rate, 230° C./2.16 kg | g/10 min | ISO 1133 | 3.0 |
| 2 | Filler Content, 1500° F./10 minutes | % | ISO 3451 | 7.3 |
| 3 | Tensile Strength, 5 mm/min | Mpa | ISO 527 | 8.2 |
| 4 | Tensile Elongation at Break, 5 mm/min | % | ISO 527 | 233.3 |
| 5 | Flexural Modulus Chord, 2 mm/min | Mpa | ISO 178 | 170 |
| 6 | Flexural Strength, 2 mm/min | Mpa | ISO 178 | 6.8 |
| 7 | Notched Charpy Impact, 23° C. | KJ/m² | ISO 180 | 30.4 |
| 8 | Notched Charpy Impact, −30° C. | KJ/m² | ISO 180 | 57.5 |
| 9 | Hardness, Shore D | | ISO 2039 | 32 |
| 10 | Softness Rating, Grain CPM541 | excellent, | APNA Method | excellent |
| 11 | Softness Rating, Grain CPM518 | acceptable or | APNA Method | acceptable |
| | | unacceptable | | |
| 12 | Multiaxial Impact, 6.7 m/s, 23° C. Energy to max load | J | ASTM D3763 | 11.1 (D) |
| 13 | Multiaxial Impact, 6.7 m/s, −30° C. Energy to max load | J | ASTM D3763 | 14.1 (D)* |

*indicates test specimen cracked, however cracks did not extend outside ring and test specimen did not shatter

Composition 26 was prepared by melt mixing using a twin-screw extruder according to the scheme in FIG. 1. The composition of 26, in weight percent of total composition, consists of the following:

| Material Supplier and | | |
|---|---|---|
| Grade Name | Material Description | X120908-H |
| Equistar Chemicals Adflex | Reactor TPO | 19.57 |
| Q200F | | |
| Dow Engage 8100 | Plastomer, Ethylene-Octene | 6.79 |
| | Copolymer | |
| Kraton G4609H | White mineral oil extended | 28.14 |
| | polystyrene-block- | |
| | poly(ethylene-co-butylene)- | |
| | block-polystyrene (SEBS) | |
| | triblock thermoplastic | |
| | elastomer | |
| Evonik Tegomer H-Si | Wax type siloxane-co- | 3.00 |
| 6440P | polyester anti-scratch | |
| | additive | |
| Chemtura Polybond 3200 | Maleic Anhydride Grafted | 1.00 |
| | Polypropylene | |
| Standridge Color | Carbon Black Masterbatch, | 1.00 |
| SSC22598 | 49% Carbon Black in LLDPE | |
| | carrier | |
| Ciba Irganox 1010 | Sterically hindered phenolic | 0.20 |
| | antioxidant | |
| Ciba Irgafos 168 | Trisaryl phosphite processing | 0.10 |
| | stabilizer | |
| Equistar Chemicals Profax | Homopolymer PP flake | 0.20 |
| 6301 | | |
| Johns Manville EC13 | 13 Micron diameter short | 40.00 |
| 738 3/16″ Thermoflow | glass fiber for PP | |
| Series | | |

Composition 26 exhibited the following properties:

| ITEM # | TEST DESCRIPTION | UNITS | TEST METHOD | X120908-H |
|---|---|---|---|---|
| 1 | Melt Flow Rate, 230° C./2.16 kg | g/10 min | ISO 1133 | 3.0 |
| 2 | Filler Content, 1500° F./10 minutes | % | ISO 3451 | 39.7 |
| 3 | Tensile Strength, 5 mm/min | Mpa | ISO 527 | 25.9 |
| 4 | Tensile Elongation at Break, 5 mm/min | % | ISO 527 | 31.6 |
| 5 | Flexural Modulus Chord, 2 mm/min | Mpa | ISO 178 | 919 |
| 6 | Flexural Strength, 2 mm/min | Mpa | ISO 178 | 22.2 |
| 7 | Notched Charpy Impact, 23° C. | KJ/m² | ISO 180 | 61.0 |
| 8 | Notched Charpy Impact, −30° C. | KJ/m² | ISO 180 | 42.8 |
| 9 | Hardness, Shore D | | ISO 2039 | 45 |
| 10 | Softness Rating, Grain CPM541 | excellent | APNA Method | acceptable |
| 11 | Softness Rating, Grain CPM518 | acceptable or | APNA Method | acceptable |
| | | unacceptable | | |
| 12 | Multiaxial Impact, 6.7 m/s, 23° C. Energy to max load | J | ASTM D3763 | 10.6 (D) |
| 13 | Multiaxial Impact, 6.7 m/s, −30° C. Energy to max load | J | ASTM D3763 | 6.7 (B) |

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims appended hereto and their equivalents.

What is claimed is:

1. A polypropylene composition with enhanced haptics comprising, based on the total weight of the composition, a melt blend of
10-90% reactor TPO;
5-65% reinforcing filler;
0-40% homopolymer polypropylene;
0-50% random copolymer polypropylene;
0-10% polyamide 6;
0-40% ethylene-C₄₋₈ α-olefin plastomer;
0-40% plastomer propylene-ethylene copolymer;
0-40% polystyrene-block-poly(ethylene-co-butylene)-block-polystyrene (SEBS) triblock thermoplastic elastomer;
0-3% anti-scratch additives;
0-3% maleic anhydride grafted PP;
0-3% antioxidants;
0-2% UV stabilizer; and
0-4% colorant.

2. The composition of claim 1 wherein the reinforcing filler is comprised of short glass fiber having a diameter between 5 and 15 Microns.

3. The composition of claim 1 wherein the reinforcing filler is comprised of short glass fiber and long glass fiber.

4. The composition of claim 3 wherein the average glass fiber length is between 0-1500 μm.

5. The composition of claim 1 wherein the flex modulus is 50-4000 MPa.

6. A process for producing a polypropylene composition with enhanced haptics comprised of mix melting a blend of
10-90% reactor TPO;
5-65% reinforcing filler;
0-40% homopolymer polypropylene;
0-50% random copolymer polypropylene;
0-10% polyamide 6;
0-40% ethylene-C₄₋₈ α-olefin plastomer;
0-40% plastomer propylene-ethylene copolymer;
0-40% polystyrene-block-poly(ethylene-co-butylene)-block-polystyrene (SEBS) triblock thermoplastic elastomer;
0-3% anti-scratch additives;
0-3% maleic anhydride grafted PP;
0-3% antioxidants;
0-2% UV stabilizer; and
0-4% colorant.

7. The process of claim 6 wherein the reinforcing filler is comprised of short glass fiber having a diameter between 5 and 15 Microns.

8. The process of claim 6 wherein the reinforcing filler is comprised of short glass fiber and long glass fiber.

9. The process of claim 8 wherein the average glass fiber length is between 0-1500 μm.

10. The process of claim 6 wherein the mix melting comprises an extruder having a primary heating area at between 380-510° F.

11. The process of claim 6 wherein the mix melting comprises an extruder having a secondary heating area at between 380-510° F.

12. The process of claim 6 wherein the mix melting comprises an extrusion having a die temperature between 380-510° F.

13. The process of claim 6 wherein the mix melting comprises an extrusion having a screw rotation between 300-1000 r.p.m.

14. The process of claim 6 wherein the mix melting comprises an extrusion having torque between 30-95%

15. The process of claim 6 wherein the reinforcing filler is added downstream.
